(19) United States
(12) Patent Application Publication
(10) Pub. No.: US 2005/0133963 A1
(43) Pub. Date: Jun. 23, 2005

(54) Silicon carbide whisker-reinforced ceramics with low rate of grain size increase upon densification

(75) Inventors: Guodong Zhan, Davis, CA (US); Joshua D. Kuntz, Lafayette, CA (US); Julin Wan, Schenectady, NY (US); Amiya K. Mukherjee, Davis, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: THE REGENTS OF THE UNIVERSITY OF CALIFORNIA, a California corporation, Oakland, CA (US)

(21) Appl. No.: 10/742,636

(22) Filed: Dec. 18, 2003

(51) Int. Cl. C04B 35/81

(52) U.S. Cl. 264/434; 501/95.3; 501/89; 264/430; 264/641

(57) ABSTRACT

A highly dense composite of a ceramic material and silicon carbide whiskers with grain sizes in the nano-sized range is formed by mechanical activation of the ceramic material in the form of a nano-sized powder, followed by compressing a mixture of the mechanically activated ceramic material and silicon carbide whiskers into a fused mass while passing an electric current through the mixture, preferably by electric field-assisted sintering. The nano-sized grains in the final microstructure provide the composite with superior mechanical properties, notably strength and toughness.

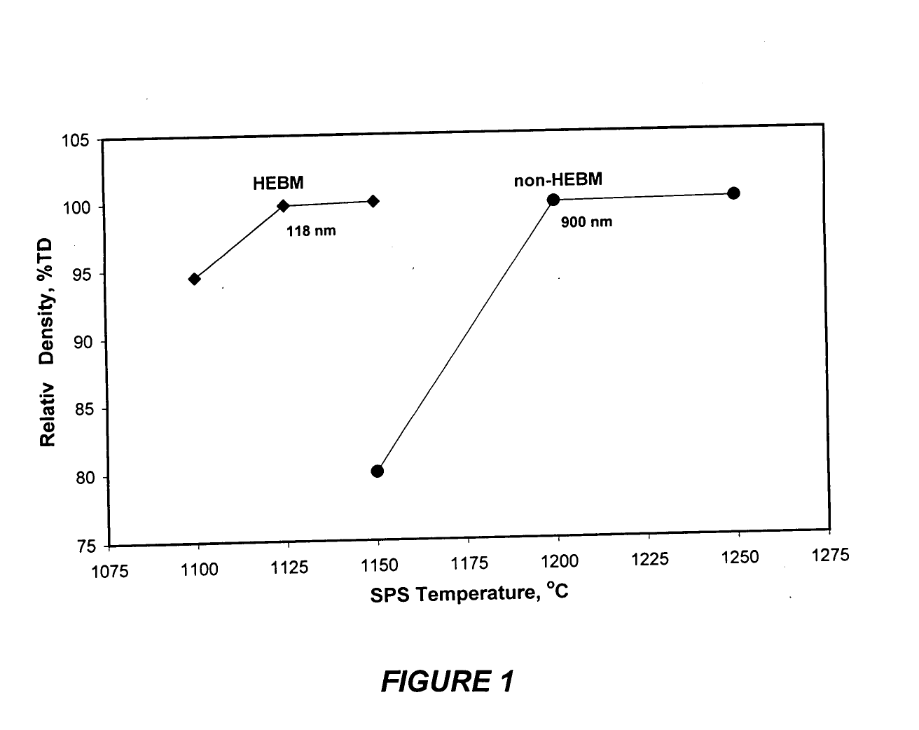

### STATEMENT AS TO RIGHTS TO INVENTIONS MADE UNDER FEDERALLY SPONSORED RESEARCH OR DEVELOPMENT

This invention was made with financial support from the United States Government under Contract No. DAAD19-00-1-0185, awarded by the United States Army Research Office. The Federal Government therefore has certain rights in this invention.

### BACKGROUND OF THE INVENTION

1. Field of the Invention

This invention resides in the field of ceramics, and incorporates technologies relating to nanocrystalline materials, silicon carbide whiskers, and sintering methods for densification and enhancement of mechanical properties.

2. Description of the Prior Art

Ceramics that have a microstructure whose crystalline grains are in the nano-size range are known to have unique mechanical properties, notably strength and toughness, that set these materials apart from ceramics with larger-grain microstructures. As a result, nanocrystalline ceramics hold promise as high-performance materials for a wide variety of applications extending from microelectromechanical devices (MEMS) to materials of construction for heat engines, cutting tools, wear and friction surfaces, and space vehicles. Fulfillment of the promise of nanocrystalline ceramics has been limited however by the problem encountered by ceramics in general, i.e., brittleness.

Among the various attempts to reduce the brittleness of ceramics, nano-sized or otherwise, the most prominent have been the development of composites in which secondary materials are dispersed throughout the ceramic matrix. One class of secondary substances are various types of fibers, notably graphite fibers and silicon carbide fibers. Graphite fibers have been shown to increase fracture toughness and strength at ambient temperatures but tend to lose their effectiveness at elevated temperatures due to oxidation of the carbon in the fibers and reaction between the carbon and the ceramic matrix material. These reactions did not occur with silicon carbide fibers, but silicon carbide filaments and chopped fibers tend to decompose and experience excessive grain growth at elevated temperatures. In addition, hot pressing results in fragmentation of the fibers and the fibers are not highly effective in making the ceramic resistant to cracking. To overcome these disadvantages, silicon carbide whiskers have been introduced. The whiskers are smaller in size than the filaments and fibers previously used and are monocrystalline in structure. Disclosures of silicon carbide whisker-reinforced ceramic composites are found in the following United States patents:

| Patent No. | Inventor(s) and Title | Issue Date |
|---|---|---|
| 4,543,345 | Wei: “Silicon Carbide Whisker Reinforced | Sep. 4, 1985 |
| | Ceramic Composites and Method for | |
| | Making Same” | |
| 4,652,413 | Tiegs: “Method for Preparing Configured | Mar. 24, 1987 |
| | Silicon Carbide Whisker-Reinforced | |
| | Alumina Ceramic Articles” | |
| 4,839,316 | Tiegs: “Protective Coating for Alumina- | Jun. 13, 1989 |
| | Silicon Carbide Whisker Composites” | |
| 4,916,092 | Tiegs et al.: “Ceramic Composites | Apr. 10, 1990 |
| | Reinforced With Modified Silicon Carbide | |
| | Whiskers” | |
| 4,994,416 | Tiegs et al.: “Ceramic Composites | Feb. 19, 1991 |
| | Reinforced With Modified Silicon Carbide | |
| | Whiskers and Method for Modifying the | |
| | Whiskers” | |
| 5,017,528 | Tiegs et al.: “Modified Silicon Carbide | May 21, 1991 |
| | Whiskers” | |
| 5,207,958 | Tiegs: “Pressureless Sintering of Whisker- | May 4, 1993 |
| | Toughened Ceramic Composites” | |
| 5,376,600 | Tiegs: “Pressureless Sintering of Whisker- | Dec. 27, 1994 |
| | Toughened Ceramic Composites” | |

The strength and toughness of ceramics and ceramic composites in general are affected by their density and crystal size, both of which vary with the method by which the powders that are used as starting materials are consolidated. One method of consolidation that is practiced in the art is that of electric field-assisted sintering, which is also known as spark plasma sintering, plasma-activated sintering, and field-assisted sintering technique. Electric field-assisted sintering is disclosed in the literature for use on metals and ceramics, for consolidating polymers, for joining metals, and for crystal growth and promoting chemical reactions. The densification of alumina powder by electric field-assisted sintering is disclosed by Wang, S. W., et al., J. Mater. Res. 15(4) (April 2000): 982-987.

The contents of all citations in this specification, including both patents and published technical papers, are incorporated herein by reference.

### SUMMARY OF THE INVENTION

It has now been discovered that silicon carbide whisker-reinforced nanocrystalline ceramics can be densified to a high degree with a low increase in grain size. This is achieved by mechanical activation of the ceramic material in nano-sized powdered form followed by compressing a mixture of the mechanically activated ceramic powder and the silicon carbide whiskers into a fused mass while passing an electric current through the mixture, preferably by electric field-assisted sintering. This invention is illustrated by alumina which is a representative of ceramic materials in general and which is of particular interest among ceramics in view of its relatively high homologous temperature. The combination of mechanical activation and electric field-assisted sintering produces the unusual and heretofore unobtained result of a highly dense material that has a retained nanocrystalline microstructure. These qualities produce a material demonstrating superior mechanical properties as evidenced by a high fracture toughness and high hardness.

These and other features, advantages and objects of this invention will be apparent from the description that follows.

### BRIEF DESCRIPTION OF THE FIGURE

The attached FIGURE is a plot of relative density vs. sintering temperature for two sets of composites formed from nano-sized alumina and silicon carbide whiskers, one set having been formed by a process including mechanical activation and the other without mechanical activation.

### DETAILED DESCRIPTION OF THE INVENTION AND PREFERRED EMBODIMENTS

Silicon carbide whiskers are short, single-crystal fibers that are typically less than 1 micron in length on the average and have a high aspect ratio (length to diameter). These whiskers are described in the technical literature and can be purchased from commercial suppliers of ceramics and other chemicals. One method of producing silicon carbide whiskers is the pyrolysis of chlorosilanes above 1,400° C. in hydrogen, either with the aid of a metallic catalyst or on graphite or silicon substrates. Another method is by the pyrolysis of rice hulls, which consist primarily of cellulose and hydrated amorphous silica. The pyrolysis is performed by heating the rice hulls in a coking furnace at 1,200° to 1,800° C. to cause a gas phase reaction between silicon suboxide and carbon. The whiskers vary in size depending on the method by which they are made and the source from which they are obtained. In most applications of the present invention, best results will be obtained with silicon carbide whiskers having diameters of from about 0.05 micrometer to about 5 micrometers, preferably from about 0.1 micrometer to about 3 micrometers, and aspect ratios of from about 5 to about 500, preferably from about 100 to about 300.

The ceramic materials that form the major component of the composites of this invention are metal oxides. Examples are alumina, magnesium oxide, magnesia spinel, titania, cerium oxide, yttria, and zirconia. Further examples are combinations of two or more of these metal oxides, and combinations that include other oxides such as silica and other metal and non-metal oxides, as well as mixed metallic oxides such as SiAlON, AlON, spinels, and calcium aluminate. Preferred metal oxides are alumina, zirconia, and titania. As noted above, the results obtained with this invention are particularly surprising when applied to alumina in view of the high homologous temperature (the absolute temperature divided by the absolute melting point temperature) at which this ceramic is sintered.

In their initial form prior to the processing steps of this invention, the ceramic materials are in the nano-size range. As applied to these initial particles, the term “nano” is used herein to denote dimensions that are less than 100 nm. The starting ceramic particles are preferably from about 1 nm to about 100 nm in diameter, and most preferably from about 3 to about 30 nm in diameter. The term “nanocrystalline” as used in the description of the sintered product refers to a broader range, however, since a certain amount of grain growth occurs during the sintering process. In some cases, this grain growth will result in grain sizes that exceed 100 nm and may increase to values as high as 150 nm or 200 nm. Nevertheless, the amount of grain growth is considerably less than the grain growth occurring in sintered products of the same relative density that have been formed from ceramics that have not undergone mechanical activation, since as demonstrated below, the latter require a higher sintering temperature to achieve the same density. The smaller degree of grain growth occurring in the practice of the present invention produces a product with significantly improved mechanical properties.

The relative amounts of ceramic material and silicon carbide whiskers can vary, although the mechanical properties and possibly the performance characteristics may vary with the proportion of silicon carbide whiskers present. In most cases, best results will be achieved with nanocomposites in which the silicon carbide whiskers constitute from about 2% to about 50% by volume of the starting powder mixture, preferably from about 5% to about 35% by volume, and most preferably from about 10% to about 30% by volume. The volume percents referred to herein are measured on the bulk starting material, i.e., the volumes of non-consolidated powders. While the starting material used in the practice of this invention is a powder mixture that may contain components other than the ceramic material and the silicon carbide whiskers, preferred starting mixtures contain only the ceramic material and the silicon carbide whiskers.

Mechanical activation in the practice of this invention is preferably achieved by high-energy ball milling. This process is known in the art and is typically performed in centrifugal, oscillating, or planetary mills that apply centrifugal, oscillating, and/or planetary action to the powder mixture with the assistance of grinding balls. The powder in these mills is ground to the desired size by impacts of many times the acceleration due to gravity. Variables such as the sizes of the milling balls, the number of milling balls used per unit amount of powder, the temperature at which the milling is performed, the length of time that milling is continued, and the power level of the mill such as the rotational speed or the frequency of impacts, can vary widely. The number and size of the milling balls relative to the amount of powder is typically expressed as the “charge ratio,” which is defined as the ratio of the mass of the milling balls to the mass of the powder. A charge ratio of at least about 1:1, and preferably from about 1:1 to about 20:1, will generally provide the best results. Impact forces of the milling balls against the powder of at least about 5 g are preferred, with about 5 g to about 100 g more preferred and about 10 g to about 50 g most preferred. The number of impacts per second is preferably at least 6, more preferably from 6 to 60, and most preferably from 10 to 50.

Mechanical activation of the ceramic material can be achieved in either of two sequences. According the first sequence, the ceramic material alone is mechanically activated prior to forming a mixture of the ceramic material with the silicon carbide whiskers. According to the second sequence, the ceramic material is first mixed with the silicon carbide whiskers and mechanical activation is performed on the mixture. The first sequence is preferred, particularly when the ceramic material is alumina.

As noted above, consolidation of the mechanically activated powder mixture is performed by a combination of pressure and an electric field. This is preferably achieved by electric field-assisted (spark plasma) sintering, which consists of passing a pulsewise DC electric current through the powder mixture while pressure is applied. The Wang et al. paper noted above describes one such method, but the conditions may vary. For most powder mixtures within the scope of this invention and for most applications, best results will generally be obtained with a densification pressure exceeding 10 MPa, preferably of from about 10 MPa to about 200 MPa, and most preferably from about 40 MPa to about 100 MPa. The preferred current is a pulsed DC electric current of from about 1,000 A/cm² to about 10,000 A/cm², most preferably from about 1,500 A/cm² to about 5,000 A/cm². Preferred temperatures are within the range of from about 900° C. to about 3,000° C., and most preferably from about 1,000° C. to about 1,300° C. Densification is typically performed by uniaxial compression under vacuum, and preferred vacuum levels for the densification are below 10 Torr, and most preferably below 1 Torr.

The benefits of the invention will be most evident when the process results in a composite that approaches full theoretical density, which is the density of the material as determined by volume averaging the densities of each of its components. A density of at least 95% of the theoretical density is sought, preferably at least 98%, and most preferably at least 99%. The term “relative density” is used herein to denote the actual density expressed as a percent of the theoretical density.

The following example is offered for purposes of illustration and is not intended to limit the scope of the invention.

### EXAMPLE

Silicon carbide whiskers were obtained from Advanced Refractory Technologies, Inc. (New York, N.Y., USA). The whiskers had diameters ranging from 0.1 to 3 microns and aspect ratios within the range of 5 to 100. The ceramic used in this example was γ-alumina with an average particle size of 32 nm, obtained from Nanophase Technologies Corporation (Darien, Ill., USA).

The alumina powder was mechanically activated by high-energy ball milling (HEBM) in a tungsten carbide vial with a tungsten carbide ball 14 mm in diameter at a charge ratio of 1:1 and polyvinyl alcohol at 1% by weight. The polyvinyl alcohol was included as a dry milling agent to prevent severe powder agglomeration. The milling jars and their contents were placed on a SPEX 8000 Mixer/Mill manufactured by SPEX CertiPrep Industries Inc. (Metuchen, N.J., USA), and milling was performed over a period of 24 hours at accelerations of up to 20 g and approximately 20 impacts per second. The milling was followed by heating the jar contents to 350° C. under vacuum to remove the polyvinyl alcohol. The resulting mechanically activated alumina powder was combined with the silicon carbide whiskers to form a powder mixture of which the silicon carbide whiskers constituted 20% by volume. Thorough mixing was achieved by wet milling the mixture in a low-speed rotary mill with zirconia milling balls in ethanol until the silicon carbide whiskers were uniformly dispersed among the alumina particles.

In a parallel preparation, the procedure described in the preceding paragraph was repeated on separate quantities of the two starting materials, except that the mechanical activation of the alumina powder was omitted.

Samples of the both powder mixtures, i.e., those with and without mechanical activation (HEBM), were then sintered by electric field-assisted sintering, using a Dr. Sinter 1050 spark plasma sintering (SPS) system (Sumitomo Coal Company, Japan) in vacuum. The samples were about 4.8 g in weight, and sintering was conducted on a graphite die using 18 kN (63 MPa) of uniaxial force and an electric square wave pulse cycle of 12 cycles on and 2 cycles off with a cycle time of about 3 ms. As they were sintered, the samples were heated to 600° C. in two minutes, and then heated at a rate of 500° C./min to various final sintering temperatures where they were maintained for 3 minutes. The temperature was monitored with an optical pyrometer focused on a depression measuring 2 mm in diameter and 5 mm in depth in the graphite die.

The sintered compacts were removed from the sintering apparatus and their densities were determined by the Archimedes method using deionized water as the immersion medium. Grain sizes were estimated from high-resolution SEM (scanning electron microscopy) of fracture surfaces, and the crystalline phases present were determined by X-ray diffraction using CuKα radiation. Fracture toughness (K_{IC}) determinations were performed on a Wilson Tukon hardness tester with a diamond Vickers indenter, using as indentation parameters of a load of 1.5 kg and a dwell time of 15 seconds.

Relative densities of the sintered products, expressed as percents of the theoretical density, are listed in Table I below and plotted in the attached figure.

TABLE I
Relative Densities and Grain Sizes in Sintered Products
vs. Sintering Temperature

| | |
|---|---|
| With HEBM | Without HEBM |

| Sintering | Relative | | Relative | |
|---|---|---|---|---|
| Temperature | Density | Grain Size | Density | Grain Size |
| 1,100° C. | 94.5% | 97 nm | | |
| 1,125° C. | 99.8% | 118 nm | | |
| 1,150° C. | 100.0% | 146 nm | 80% | <100 nm |
| 1,200° C. | | | 99.8% | ˜900 nm |
| 1,250° C. | | | 100.0% | ˜1,000 nm |

For comparison, pure alumina, when sintered at 1,150° C. under the same conditions as the samples described above but without mechanical activation, has a relative density of 100% and a grain size of 349 nm.

The values in the table and figure show that the combination of high-energy ball milling and spark plasma sintering produces a fully dense composite of alumina and silicon carbide whiskers at a much lower sintering temperature, and exhibits much less growth in grain size, than spark plasma sintering without mechanical activation.

The mechanical properties of the various samples are listed in Table II below.

TABLE II
Mechanical Properties of Sintered Products
vs. Sintering Temperature

| | With HEBM | | Without HEBM | |
|---|---|---|---|---|
| Sintering | Hardness | Toughness | Hardness | Toughness |
| Temperature | (GPa) | (MPam^{1/2}) | (GPa) | (MPam^{1/2}) |
| 1,100° C. | 12.0 ± 0.32 | 8.66 ± 0.80 | | |
| 1,125° C. | 26.1 ± 0.33 | 6.17 ± 0.81 | | |
| 1,150° C. | 26.4 ± 0.29 | 6.00 ± 0.72 | | |
| 1,200° C. | | | 24.2 ± 0.50 | 6.64 ± 0.12 |
| 1,250° C. | | | 23.1 ± 0.36 | 7.10 ± 0.38 |

For comparison, pure alumina, when sintered at 1,150° C. under the same conditions as the samples described above but without mechanical activation, has a hardness of 20.3 GPa and a toughness of 3.30±0.14 MPam^{1/2}. The data in Table II show that the hardness values of mechanically activated composites sintered at temperatures between 1,100° C. and 1,200° C. are superior to those of the composites sintered at 1,200° C. and above without mechanical activation, with no significant difference in toughness.

The foregoing is offered for purposes of illustration and explanation. Further variations, modifications and substitutions that, even though not disclosed herein, still fall within the scope of the invention may readily occur to those skilled in the art.

1. A process for forming a dense ceramic-based material, said process comprising:
(a) mechanically activating ceramic metal oxide particles averaging less than 100 nanometers in diameter; and
(b) compressing a mixture of silicon carbide whiskers and said ceramic metal oxide particles thus activated while passing an electric current through said mixture, to consolidate said mixture into a fused mass.

2. The process of claim 1 wherein said ceramic metal oxide is a member selected from the group consisting of alumina, silica, zirconia, titania, magnesium oxide, magnesia spinel, cerium oxide, and yttria.

3. The process of claim 1 wherein said ceramic metal oxide is a member selected from the group consisting of alumina, zirconia, and titania.

4. The process of claim 1 wherein said ceramic metal oxide is alumina.

5. The process of claim 1 wherein step (a) comprises mechanically activating said ceramic metal oxide particles in the absence of silicon carbide whiskers, and said process further comprises combining said ceramic metal oxide particles thus activated with said silicon carbide whiskers, after step (a) and before step (b), to form said mixture.

6. The process of claim 1 wherein said silicon carbide whiskers constitute from about 2% to about 50% by volume of said mixture of step (b).

7. The process of claim 1 wherein said silicon carbide whiskers constitute from about 5% to about 35% by volume of said mixture of step (b).

8. The process of claim 1 wherein said silicon carbide whiskers constitute from about 10% to about 30% by volume of said mixture of step (b).

9. The process of claim 1 wherein said silicon carbide whiskers have diameters of from about 0.05 micrometer to about 5 micrometers and length-to-diameter ratios of from about 5 to about 500.

10. The process of claim 1 wherein said silicon carbide whiskers have diameters of from about 0.1 micrometer to about 3 micrometers and length-to-diameter ratios of from about 100 to about 300.

11. The process of claim 1 wherein said ceramic metal oxide particles of step (a) average from about 1 nanometers to about 100 nanometers in diameter.

12. The process of claim 1 wherein said ceramic metal oxide particles of step (a) average from about 3 nanometers to about 30 nanometers in diameter.

13. The process of claim 1 wherein step (a) comprises milling said ceramic metal oxide particles in a ball mill in which said particles collide with milling balls at a force of at least about 5 g, an impact rate of at least 6 impacts per second, and a charge ratio of at least about 1:1.

14. The process of claim 1 wherein step (a) comprises milling said ceramic metal oxide particles in a ball mill in which said particles collide with milling balls at a force of from about 5 g to about 100 g, an impact rate of from 6 to 60 impacts per second, and a charge ratio of at least 1:1.

15. The process of claim 1 wherein step (a) comprises milling said ceramic metal oxide particles in a ball mill in which said particles collide with milling balls at a force of from about 10 g to about 50 g, an impact rate of from 10 to 50 impacts per second, and a charge ratio of at least about 1:1.

16. The process of claim 1 wherein step (b) comprises compressing said mixture at a pressure of about 10 MPa to about 200 MPa and a temperature of from about 900° C. to about 3,000° C., and said electric current is a pulsed direct current of about 1,000 A/cm² to about 10,000 A/cm².

17. The process of claim 16 wherein said pressure is about 40 MPa to about 100 MPa.

18. The process of claim 16 wherein said temperature is about 1,000° C. to about 1,300° C.

19. The process of claim 16 wherein said pulsed direct current is about 1,500 A/cm² to about 5,000 A/cm .

20. The process of claim 1 wherein step (a) comprises milling said ceramic metal oxide particles in a ball mill in which said particles collide with milling balls at a force of at least about 5 g, an impact rate of at least 6 impacts per second, and a charge ratio of at least about 1:1, and step (b) comprises compressing said mixture at a pressure of about 10 MPa to about 200 MPa and a temperature of from about 900° C. to about 3,000° C., and said electric current is a pulsed direct current of about 1,000 A/cm² to about 10,000 A/cm².

21. The process of claim 1 wherein step (a) comprises milling said ceramic metal oxide particles in a ball mill in which said particles collide with milling balls at a force of from about 10 g to about 50 g, an impact rate of 10 to 50 impacts per second, and a charge ratio of 1:1 to 20:1, and step (b) comprises compressing said mixture at a pressure of about 40 MPa to about 100 MPa and a temperature of from about 1,000° C. to about 2,000° C., and said electric current is a pulsed direct current of about 1,500 A/cm² to about 5,000 A/cm².

22. A dense composite of a ceramic metal oxide and silicon carbide whiskers prepared by the process of claim 1.

23. A dense composite comprising alumina and silicon carbide whiskers prepared by the process of claim 4.

24. A dense composite comprising alumina and silicon carbide whiskers wherein said silicon carbide whiskers comprise from about 2% to about 50% by volume of said composite, said composite prepared by the process of claim 6.

25. A dense composite comprising gamma-alumina and silicon carbide whiskers wherein said silicon carbide whiskers comprise from about 10% to about 30% by volume of said composite, said composite prepared by the process of claim 8.

26. A dense composite comprising ceramic metal oxide and silicon carbide whiskers prepared by the process of claim 13.

27. A dense composite comprising ceramic metal oxide and silicon carbide whiskers prepared by the process of claim 15.

28. A dense composite comprising ceramic metal oxide and silicon carbide whiskers prepared by the process of claim 20.

29. The dense composite of claim 28 in which said ceramic metal oxide is alumina.

30. A dense composite comprising ceramic metal oxide and silicon carbide whiskers prepared by the process of claim 21.

31. The dense composite of claim 30 in which said ceramic metal oxide is alumina.
